(19) United States
(12) Patent Application Publication
(10) Pub. No.: US 2005/0094780 A1
(43) Pub. Date: May 5, 2005

(54) Service(s) provided to telephony device through employment of data stream(s) associated with call

(76) Inventor: Edward Alan Clark, Sugar Grove, IL (US)

Correspondence Address: PATTI & BRILL, ONE NORTH LASALLE STREET, 44TH FLOOR, CHICAGO, IL, 60602, US

(21) Appl. No.: 10/698,141

(22) Filed: Oct. 31, 2003

(51) Int. Cl. H04M 11/00; H04M 1/64

(52) U.S. Cl. 379/88.13; 379/88.17

(57) ABSTRACT

A Customer Premise Equipment application server component that provides one or more services to a telephony device on a call through employment of one or more data streams associated with the call.

### CROSS-REFERENCE TO RELATED APPLICATIONS

This application contains subject matter which is related to the subject matter of the following application, which are assigned to the same assignee as this application. The below-listed applications are hereby incorporated herein by reference in their entireties:

“DATA STREAM ASSOCIATION WITH CALL THROUGH EMPLOYMENT OF IDENTIFIER WITHIN MESSAGES ASSOCIATED WITH THE CALL,” by Clark, et al., co-filed herewith.

“SERVICE(S)PROVIDED TO TELEPHONY DEVICE(S) THROUGH EMPLOYMENT OF DATA STREAM(S) ASSOCIATED WITH THE CALL,” by Edward A. Clark, co-filed herewith.

“TRANSMISSION OF USER INPUT(S) TO TELEPHONY DEVICE(S) THROUGH EMPLOYMENT OF DATA STREAM(S) ASSOCIATED WITH CALL,” by Edward A. Clark, co-filed herewith.

### TECHNICAL FIELD

The invention relates generally to telecommunications systems and more particularly to providing services through employment of data streams associated with the call.

### BACKGROUND

A user of Customer Premise Equipment (“CPE”) initiates a call on a network. The CPE in one example comprises a telephony device. The CPE in one example employs a call request signaling, for example, a Dual Tone Multi Frequency (“DTMF”) protocol, to initiate the call. The user of the CPE initiates the call to an application server component that provides one or more services associated with the user of the CPE, for example, a voice mail service.

For example, the application server component provides the user of the CPE with one or more voice menus, such as a mailbox management menu. In order to interact with the one or more services, the user of the called CPE interacts with the voice menus by initiating one or more touch-tones and/or voice commands. For example, the user of the called CPE presses 0 and/or says “zero” to play the first message.

The application server component receives the touch-tones and/or voice commands in one or more messages associated with the call from one or more network elements. The application server component provides the services based upon the information present in the messages associated with the call, for example, the touch-tones and/or voice commands. The services provided by the application server component are limited to the information provided in the messages received from network elements, such as the application server component and/or a switch component, associated with the call. As one shortcoming, the restriction of the services provided by the application server component to the information provided in the messages undesirably limits the types of services provided to the users of the CPEs.

Thus, a need exists to provide one or more services that are not limited to the information present in the one or more messages received from the network.

### SUMMARY

The invention in one embodiment encompasses an apparatus. A Customer Premise Equipment (CPE) application server component that provides one or more services to a telephony device on a call through employment of one or more data streams associated with the call

Another embodiment of the invention encompasses a method. One or more CPEs provide one or more services to a telephony device on a call through employment of one or more data streams associated with the call.

Yet another embodiment of the invention encompasses an article. The article comprises one or more computer-readable signal-bearing media. The article comprises means in the one or more media for providing, by one or more CPEs, one or more services to a telephony device on a call through employment of one or more data streams associated with the call.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises one or more application server components, one or more switch components, one or more telephony devices, one or more networks, and one or more signaling networks.

FIG. 2 is a representation of a second exemplary implementation of the apparatus of FIG. 1.

FIG. 3 is a representation of an exemplary process flow of a first establishment of a data stream associated with an interactive voice response call between a first application server component and a second application server component of the apparatus of FIG. 1.

FIG. 4 is a representation of an exemplary process flow of a first establishment of a data stream associated with a voice mail call between a first application server component and a second application server component of the apparatus of FIG. 1.

FIG. 5 is a representation of an exemplary message employed in establishment of the data stream by the application server component and the switch component of the apparatus of FIG. 1.

FIG. 6 is a representation of another exemplary message employed in establishment of the data stream by the application server component and the switch component of the apparatus of FIG. 1.

FIG. 7 is a representation of yet another exemplary message employed in establishment of the data stream by the application server component and the switch component of the apparatus of FIG. 1.

### DETAILED DESCRIPTION

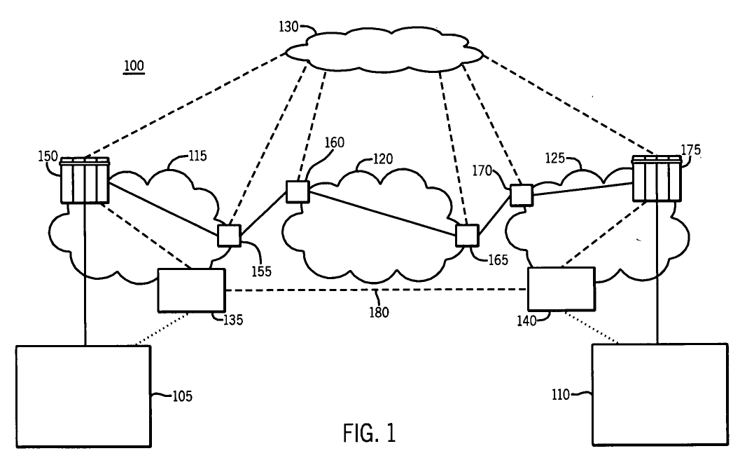

Turning to FIG. 1, an apparatus 100 in one example comprises one or more telephony devices 105 and 110, and one or more networks 115, 120, 125, and 130. The telephony device 105 in one example comprises one or more Customer Premise Equipments (“CPEs”), such as a computer, a web-enabled device, and/or a telephone. The telephony device 110 in one example comprises an interactive voice response system. The telephony devices 105 and 110 initiate and/or receive one or more calls. In one example, the telephony device 105 initiates a call to the telephony device 110. In another example, the telephony device 105 receives a call initiated by the telephony device 110.

The telephony devices 105 and 110 initiate calls through employment of a call request signaling. The call request signaling in one example comprises a Dual-Tone Multi-Frequency (“DTMF” or Touch Tone) signaling, as will be understood by those skilled in the art. The telephony device 105 and 110 initiate calls on the networks 115, 120, 125, and/or 130.

The networks 115, 120, and 125 in one example comprise one or more service provider networks. In one example, the networks 115, 120, and 125 comprise a Public Switched Telephony Network (“PSTN”) and/or an Integrated Services Digital Network (“ISDN”). The network 130 in one example comprises a signaling network, for example, a Signaling System 7 (“SS7”) network. The networks 115, 120, 125, and 130 in one example comprise one or more application server components 135 and 140, and one or more switch components 150, 155, 160, 165, 170, and 175.

One or more of the networks 115, 120, 125, and 130 communicate with one or more other of the networks 115, 120, 125, and/or 130 through employment of one or more call control protocols. The one or more call control protocols in one example comprises an Integrated Services Digital Network User Part (“ISUP”) protocol, the Session Initiation Protocol (“SIP”), the Bearer Independent Call Control (“BICC”) protocol, and the Transaction Capabilities Application Part (“TCAP”) protocol. The networks 115, 120, 125, and/or 130 establish calls from the telephony device 105 to the telephony device 110.

The application server components 135 and/or 140 comprise one or more application servers. The application server components 135 and/or 140 in one example comprise one or more CPEs. The CPEs in one example are associated with one or more of the telephony devices 105 and/or 110. One or more of the application server components 135 and/or 140 communicate with one or more other of the application server components 135 and/or 140 through employment of one or more data stream control protocols. The data stream control protocols in one example comprise one or more of: the User Datagram Protocol (“UDP”), the Transfer Control Protocol (“TCP”), and the Session Initiation Protocol (“SIP”).

One or more of the application server components 135 and/or 140 communicate with one or more of the one or more switch components 150, 155, 160, 165, 170, and/or 175 through employment of one or more service control protocols. The service control protocol in one example comprises the Session Initiation Protocol (“SIP”). The application server components 135 and/or 140 in one example communicate with the switch components 150, 175, and 160, respectively.

The switch components 150, 155, 160, 165, 170, and 175 in one example comprise one or more telephony switches, for example, one or more Service Switching Points (“SSPs”). The switch components 150, 155, 160, 165, 170, and/or 175 communicate with the telephony devices 105 and/or 110 through employment of the call request signaling. The switch components 150, 155, 160, 165, 170, and/or 175 communicate with one or more of the switch components 150, 155, 160, 165, 170, and/or 175 through employment of one or more of the one or more call control protocols.

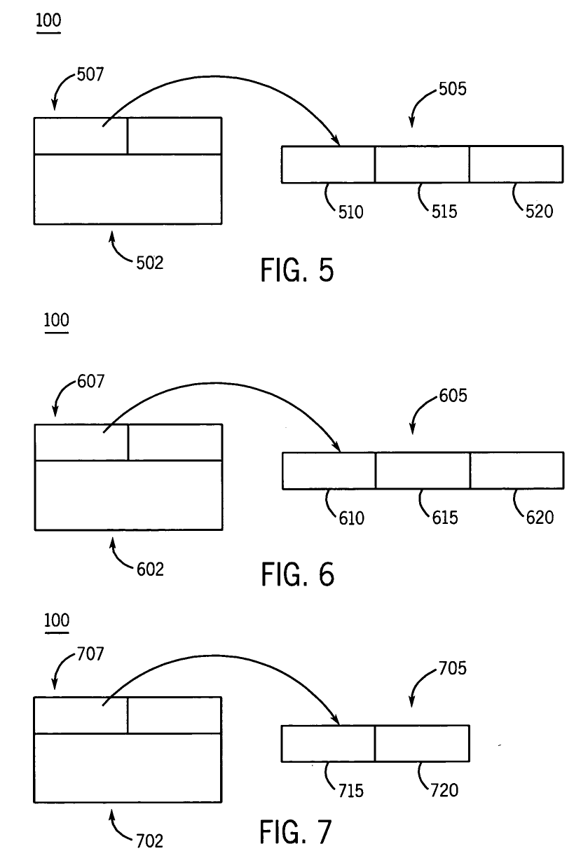

In one example, the switch components 150, 155, 160, 165, 170, and/or 175 employ one or more messages 502 (FIG. 5), for example, one or more initiation messages, to establish a call. In another example, the switch components 150, 155, 160, 165, 170, and/or 175 employ one or more messages 602 (FIG. 6), for example, one or more request-back messages during establishment of the call. The messages 502 and the messages 602 in one example conform to the call control protocol.

The application server components 135 and/or 140 establish one or more data streams, for example, a data stream 180, with one or more of the application server components 135 and/or 140. The application server components 135 and/or 140 associate the data stream 180 with a call. The application server components 135, 140, and/or 145 employ the data stream 180 to provide one or more services for the call. The application server components 135 and/or 140 establish the data stream 180 through employment of one or more identifiers 505 (FIG. 5), 605 (FIG. 6) and/or 705 (FIG. 7). The application server components 135 and/or 140 employ the identifiers 505, 605, and/or 705 to associate the data stream 180 with the call.

An identifier 505 in one example comprises a network address 510, a port 515, and an identification tag 520. The network address 510 in one example comprises an Internet Protocol (“IP”) address associated with one of the application server components 135, 140, and/or 145. The port 515 comprises a port number, for example, port 8080, associated with one of the application server components 135, 140, and/or 145. The port 515 in one example is associated with the one or more services provided by the application server components 135, 140, and/or 145 for a call. The identification tag 520 serves to uniquely identify the call, as will be appreciated by those skilled in the art.

The application server components 135 and/or 140 establish the data stream 180 through employment of one or more messages 702 (FIG. 7), for example, one or more data stream request messages. Wherein a message 702 comprises a data stream request message, the application server components 135 and/or 140 provide a portion of the identifier 505 within the message 702. The message 702 conforms to one or more of the data stream control protocols.

Referring to FIGS. 5-7, the message 502 and 602 conform to the call control protocol. The message 702 conforms to the data stream request protocol. The messages 502, 602, and 702 comprise one or more generic parameters 507, 607, and 707. The generic parameters 507 and 607 in one example comprise one or more Generic Address Parameters (“GAPs”).

The message 502 in one example comprises the initiation message. The message 502 comprises the generic parameter 507. The generic parameter 507 in one example comprises the identifier 505. The switch component 150 and the application server component 135 in one example provide the identifier 505 within the generic parameter 507.

The message 602 in one example comprises a request-back message. The message 602 comprises the generic parameter 607. The generic parameter 607 in one example comprises the identifier 605. The identifier 605 in one example comprises a network address 610, a port 615, and an identification tag 620.

The message 702 in one example comprises a data stream request message. The message 702 comprises a portion of an identifier, for example, the identifier 505, within the generic parameter 707 of the message 702. The generic parameter 707 comprises a port 715 and an identification tag 720. In one example, the port 715 comprises the port 515 or 615. In another example, the identification tag 720 comprises the identification tag 520 or 620. The application server component 135 in one example routes the message 702 to a network address 710.

For example, the network address 710, the port 715, and the identification tag 720 comprise the network address 510, the port 515, and the identification tag 520. In another example, the network address 710, the port 715, and the identification tag 720 comprise the network address 610, the port 615, and the identification tag 620.

The application server components 135 and/or 140 associate a call with the identifiers 505 of a plurality of identifiers 505 and/or identifier 605 of a plurality of identifier 605. The application server components 135 and/or 140 in one example select the identifier 505 and/or 605 from the plurality of identifiers 505 and/or 605 such that the identifier 505 and/or 605 uniquely identifies the call.

For example, the application server component 135 selects a first identifier 505 to associate with a first call, and a second identifier 505 to associate with a second call. The application server component 135 distinguishes the first call from the second call through employment of the first identifier 505 and the second identifier 505, as will be appreciated by those skilled in the art. In one example, the application server component 135 selects the identifier 505 and/or 605 from the plurality of identifiers 505 and/or 605 available for a call through employment of a random selection method. In another example, the application server component 135 employs a static selection method to select the identifier 505 and/or 605.

In yet another example, the application server component 135 employs a priority selection method to select the identifier 505 and/or 605. In still yet another example, the application server component 135 selects the identifier 505 and/or 605 based on information associated with a call provided by the switch component 150.

For example, where the application server component 135 selects the identifier 505, the application server component 135 selects: the network address 510 of a plurality of network addresses 510 associated with the application server component 135; the port 515 of a plurality of ports 515 associated with the application server component 135; and the identification tag 520 of a plurality of identification tags 520 associated with the application server component 135.

In another example, the application server component 140 associates the identifier 505 with a call through employment of the message 502, for example, the initiation message. The message 502 associated with the call in one example comprises the identifier 505. Upon receipt of the message 502, the switch component 175 communicates with the application server component 140 to provide the identifier 505 to the application server component 140. The application server component 140 stores the identifier 505.

The application server components 135 and/or 140 in one example associate the data stream 180 with calls through employment of the identifiers 505 and/or 605. The application server components 135 and/or 140 in one example employ the identifier 505 to distinguish a first data stream 180 associated with the first call from a second data stream, for example, a second data stream 180, associated with the second call.

For example, the application server component 135 associates the first call with the first identifier 505. The application server components 135 and 140 cooperate to establish the first data stream 180 associated with the first call. The application server component 135 associates the second call with the second identifier 505. The application server components 135 and 140 cooperate to establish the second data stream 180 associated with the second call. The application server component 135 employs the first identifier 505 and the second identifier 505 to distinguish the data stream 180 associated with the first call from the second data stream 180 associated with the second call.

In one example, the application server components 135 and/or 140 provide the one or more services through employment of the data stream 180. In another example, the application server components 135 and/or 140 in one example cooperate through employment of the data stream 180 to update the one or more services provided to the telephony devices 105 and/or 110. In another example, the application server components 135 and/or 140 transfer data related to the one or more services through employment of the data stream 180. The application server components 135 and/or 140 employ the data to provide the one or more services to the telephony devices 105 and 110.

In one example, the application server components 135 and/or 140 employ the data to form one or more interfaces associated with the one or more services. For example, the application server component 135 transfers data to form a first interface to the application server component 140. The application server component 140 transfers data to form a second interface to the application server component 135.

The interfaces in one example comprise one or more eXtended Markup Language (“XML”) interfaces. The application server components 135 and/or 140 in one example provide the interfaces to the telephony device 105 and/or 110. The application server components 135 and/or 140 employ one or more internet protocols such as HyperText Transfer Protocol (“HTTP”) to provide the interfaces to the telephony devices 105 and/or 110.

The application server components 135 and/or 140 in one example provide the one or more services on a call-by-call basis through employment of the identifier 505. The application server components 135 and/or 140 employ the identifier 505 to distinguish a first one or more services associated with the first call from a second one or more services associated with the second call. For example, the application server component 135 employs the first identifier 505 to provide the first one or more services through employment of the data stream 180. The application server component 135 employs the second identifier 505 to provide the second one or more services through employment of the data stream 185.

In one example, one or more of the switch components 150, 155, 160, 165, 170, and/or 175 cooperate to establish calls. The switch components 150, 155, 160, 165, 170, and/or 175 provide the identifier within the messages 502 and/or 602 associated with the call. In one example, the switch components 150, 155, 160, 165, 170, and/or 175 associate the calls with the identifier 505 and/or 605. The switch components 150, 155, 160, 165, 170, and/or 175 cooperate with the application server components 135, 140, and/or 145 to provide the one or more services for the respective calls.

The switch components 150, 155, 160, 165, 170, and/or 175 establish a call through employment of the message 502, for example, the initiation message, and/or the message 602, for example, the request-back message. The Integrated Services Digital Network User Part protocol comprises the message 502, for example, an Initial Address Message (“IAM”), and the message 602, for example, a Call ProGress (“CPG”) message.

The switch components 150, 155, 160, 165, 170, and/or 175 provide the identifier 505 within the message 502 and/or the identifier 605 within the message 602 associated with a call. In one example, the switch component 150 inserts the identifier 505 into the generic parameter 507 of the message 502. In another example, switch component 175 inserts the identifier 605 into the generic parameter 607 of the message 602.

For example, the switch component 150 is pre-provisioned to communicate with the application server component 135 upon receipt of the message 502, and/or message 602, where the message 502 comprises the initiation message, and/or the message 602 comprises the request-back message. The switch component 150 provides the identifier 505 from within the message 502 and/or the message 602 to the application server component 135. In another example, the switch component 175 is pre-provisioned to communicate with the application server component 140 to obtain the identifier 505 upon sending of the message 502 and/or the message 602 from the switch component 175.

The message 502, for example, the initiation message, is received by the switch component 175. Where the message 502 omits the identifier 505, the switch component 175 communicates with the application server component 140 to obtain the identifier 605. The switch component 175 inserts the identifier 605 into the message 602, for example, the request-back message. The switch component 175 sends the message 602 to the switch component 150.

The switch components 150, 155, 160, 165, 170, and/or 175 associate the identifier 505 with a call. The switch components 150, 155, 160, 165, 170, and/or 175 associate the identifier 505 with the call through employment of the message 502. For example, the switch component 150 associates the identifier 505 with the call established by the message 502 through employment of the message 502.

Where a user of the telephony device 105 establishes the call, the switch components 150, 155, 160, 165, 170, and/or 175 cooperate with the application server components 135 and/or 140 to provide the one or more services for the call. For example, the application server components 135 and/or 140 cooperate to provide the one or more services associated with the call to the telephony devices 105 and 110. In one example, where a user of the telephony device 105 interacts with the call, for example, through a touch-tone selection, the application server component 140 and the switch component 175 cooperate to update the one or more services associated with the call through employment of the identifier 505 and/or 605.

In another example, the user of the telephony device 105 performs one or more interactions with the interfaces provided by the application server components 135 and/or 140. For example, the user of the telephony device 105 employs one interface to perform a request for a service. The application server component 135 employs the identifier 505 associated with a call to communicate an interaction to the switch component 175. The switch component 175 employs the identifier 505 to update the call.

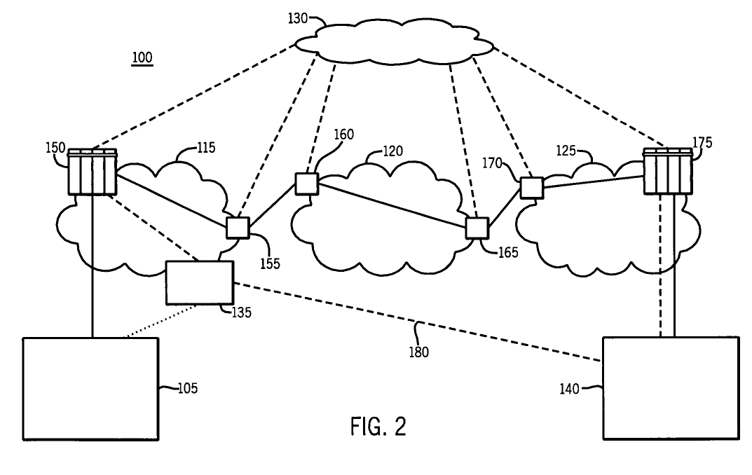

Turning to FIG. 2, the apparatus 100 in one example comprises the telephony device 105, and the networks 115, 120, 125, and 130. In one example, the application server component 140 in one example comprises Customer Premise Equipment. The application server component 140 provides one or more services on behalf of an end-user, for example, the user of the telephony device 105. In another example, the application server component 140 is owned by a service provider, for example, AT&T, and a user of the telephony device 105 purchases the one or more services. The application server component 140 in one example comprises a voice mail system. The application server component 145 provides one or more voice mail services associated with a call.

The user of the telephony device 105 establishes a voice mail call with the application server component 140 (e.g., the voice mail system) by dialing a number associated with the application server component 140. The application server components 135 and 140 cooperate to establish the one or more data streams, for example, the data stream 180. The application server components 135 and 140 cooperate to provide the one or more services, for example, the one or more voice mail services, associated with the voice mail call. The application server components 135 and 140 employ the one or more data streams associated with the voice mail call to provide the one or more interfaces associated with the voice mail call the user of the telephony device 105.

An illustrative description of exemplary operation of the apparatus 100 is presented, for explanatory purposes.

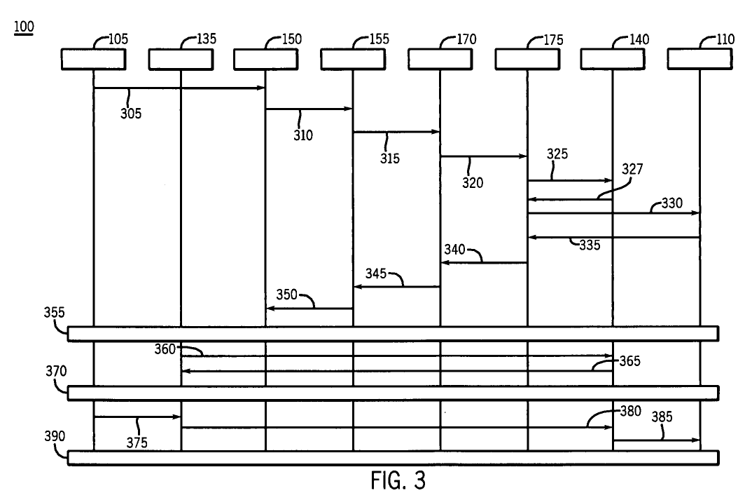

Turning to FIGS. 1 and 3, a user of the telephony device 105 initiates a call, for example, an interactive voice response call, to the telephony device 110, for example, the Interactive Voice Response system. In STEP 305, the telephony device 105 communicates with the switch component 150 to initiate the interactive voice response call. In STEP 310, the switch component 150 sends the message 502, for example, an Initial Address Message (“IAM”), to the switch component 155. In STEP 315, the switch component 155 routes the message 502 to the switch component 170. In STEP 320, the switch component 170 routes the message 502 to the switch component 175. The switch component 175 is pre-provisioned to communicate with the application server component 140.

In STEP 325, the switch component 175 communicates with the application server component 140 to obtain the identifier 505 associated with the interactive voice response call. In STEP 327, the application server component 140 associates the identifier 605 with the interactive voice response call and returns the identifier 605 to the switch component 175. In STEP 330, the switch component 175 routes the interactive voice response call to the telephony device 110. In STEP 335, the telephony device 110 indicates the call delivery by sending a first call delivery message, for example, a Q.931 CONNECT message, to the switch component 175. In STEP 340, the switch component 175 indicate the call delivery with a second call delivery message, for example, an ANSI Answer Message (“ANM”). The second call delivery message includes the call identifier 605. In STEPS 345 and 350, the switch components 170 and 155 route the second call delivery message to the switch component 150.

In STEP 355, the telephony device 110 plays a voice menu to the telephony device 105. In STEP 360, the application server component 135 initiates the data stream request message 702, (e.g., the SIP INVITE message) to the application server component 140 through employment of the identifier 605 from within the message 602. In STEP 365, the application server component 140 responds to the data stream request message 702 by sending a response message, for example, a SIP 200 OK message.

In STEP 370, the application server components 135 and 140 cooperate to establish the data stream 180. The application server component 135 establishes one or more web portals with the telephony device 105. The application server component 140 establishes one or more web portals with the telephony device 110. The application server components 135 and 140 cooperate to provide an interface, for example, a graphical user interface associated with the voice menu, to the user of the telephony device 105 through employment of the one or more web portals.

In STEP 375, the user of the telephony device 105 performs a selection of one service from the interface. In STEP 380, the application server component 135 sends the selection to the application server component 140 through employment of the data stream 180. In STEP 385, the application server component 140 provides the selection to the telephony device 110 through employment of the one or more web portals. In STEP 390, the telephony device 110 halts providing the voice menu and routes the interactive voice response call based on the selection.

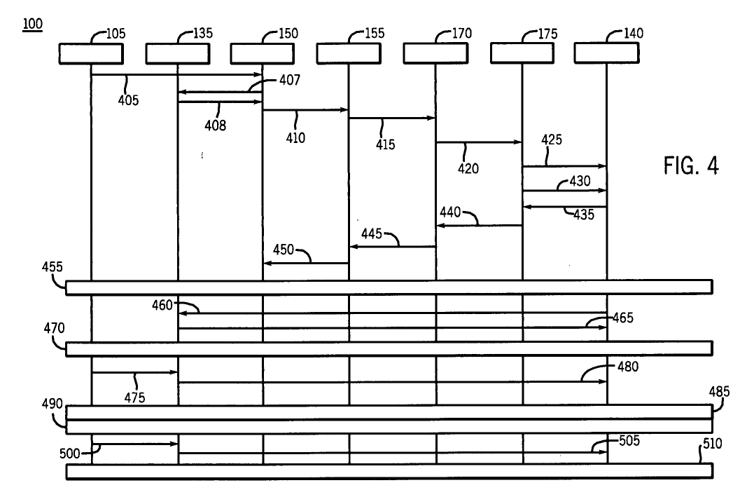

Turning to FIGS. 2 and 4, the user the telephony device 105 initiates a call, for example, a voice mail call, to the application server component 140, for example, the voice mail system. In STEP 405, the telephony device 105 communicates with the switch component 150 to initiate the voice mail call. In STEP 407, the switch component 150 communicates with the application server 135 to obtain the identifier 505 associated with the voice mail call. In STEP 408, the application server component 135 associates the identifier 505 with the voice mail call and returns the identifier 505 to the switch component 150. In STEP 410, the switch component 150 sends the message 502, for example, an Initial Address Message (“IAM”), to the switch component 155. In STEP 415, the switch component 155 routes the message 502 to the switch component 170. In STEP 420, the switch component 170 routes the message 502 to the switch component 175. The switch component 175 is pre-provisioned to communicate with the application server component 140.

In STEP 425, the switch component 175 routes the voice mail call to the telephony device 110 through employment of a Q.931 SETUP message. In STEP 430, the switch component 175 provides the identifier 505 within the message 502 to the application server component 140 through employment of a Q.931 FACILITY message. In STEP 435, the application server component 140 indicates delivery of the voice mail call by sending the first call delivery message, for example, the Q.931 CONNECT message, to the switch component 175. In STEP 440, the switch component 175 initiates the second call delivery message, for example, the ANSI Answer Message, in response to the first answer message, to the switch component 170. In STEPS 445 and 450, the switch components 170 and 155 route the second answer message to the switch component 150.

In STEP 455, the application server component 140 (e.g., the voice mail system) plays a voice menu to the user of the telephony device 105. In STEP 460, the application server component 140 initiates the data stream request message 702, (e.g., the SIP INVITE message) to the application server component 135 through employment of the identifier 505 from within the message 502. In STEP 465, the application server component 135 responds to the data stream request message 702 by sending a response message, for example, a SIP 200 OK message.

The application server components 135 and 140 cooperate to establish the data stream 180. The application server component 135 establishes one or more web portals with the telephony device 105. The application server component 140 establishes one or more web portals with the telephony device 110. In STEP 470, the application server components 135 and 140 cooperate to provide a first one or more services associated with the voice mail call through employment of a first interface, for example, a voice mail system management interface, to the user of the telephony device 105 through employment of the one or more web portals.

In STEP 475, the user of the telephony device 105 selects from the first interface, a voice mail message to hear. In STEP 480, the application server component 135 communicates with the application server component 140 through employment of the data stream 180 to play the voice mail message. In STEP 485, the application server component 140 (e.g., the voice mail system) plays the voice mail message to the user of the telephony device 105.

In STEP 490, the application server component 140 updates the voice menu to provide a second one or more services associated with the voice mail message. The application server components 135 and 140 cooperate to provide a second interface, for example, a voice mail message management interface, to the user of the telephony device 105.

In STEP 500, the user of the telephony device 105 selects to delete the voice mail message from the voice mail management interface. In STEP 505, the application server component 135 communicates with the application server component 140 through employment of the data stream 180 to delete the voice mail message. In STEP 510, the application server component 140 updates the voice menu.

The apparatus 100 in one example comprises a plurality of components such as computer software and/or hardware components. A number of such components can be combined or divided in the apparatus 100. For example, one or more of the application server components 135 and/or 140 may be combined with one or more of the switch components 150, 155, 160, 165, 170, and/or 175. An exemplary component of the apparatus 100 employs and/or comprises a set and/or series of computer instructions written in or implemented with any of a number of programming languages, as will be appreciated by those skilled in the art.

The apparatus 100 employs at least one computer-readable signal-bearing medium. One example of a computer-readable signal-bearing medium for the apparatus 100 comprises an instance of a recordable data storage medium such as one or more of a magnetic, electrical, optical, biological, and atomic data storage medium. The recordable data storage medium in one example comprises the storage device 101. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a Customer Premise Equipment (CPE) application server component that provides one or more services to a telephony device on a call through employment of one or more data streams associated with the call.

2. The apparatus of claim 1, wherein the CPE application server component establishes the one or more data streams with a user-related application server component;
wherein the CPE application server component provides the one or more services to the user-related application server component through employment of the one or more data streams.

3. The apparatus of claim 2, wherein the user-related application server component establishes one or more web portals with the telephony device;
wherein the CPE application sever component and the user-related application server component provide the one or more services to the telephony device through employment of the one or more web portals.

4. The apparatus of claim 3, wherein the CPE application server component and the user-related application server component provide one or more interfaces associated with the one or more services through employment of the one or more web portals.

5. The apparatus of claim 3, wherein the CPE application server component and the telephony device establish the call;
wherein the CPE application server component provides one or more interfaces to allow the telephony device to initiate a request to the CPE application server component;
wherein in response to the request from the telephony device to the CPE application server component, the CPE application server component alters the call.

6. The apparatus of claim 5, wherein the call comprises a voice menu, wherein the CPE application server component updates the voice menu based on the request.

7. The apparatus of claim 6, wherein a plurality of voice menus comprise the voice menu, wherein the CPE application server component provides a first voice menu of the plurality of voice menus to the telephony device;
wherein in response to the request from the telephony device to the CPE application server component, the CPE application server component halts the first voice menu and provides a second voice menu of the plurality of voice menus based on the employment of the one or more services.

8. The apparatus of claim 5, wherein in response to the request from the telephony device to the CPE application server component, the CPE application server component routes the call.

9. The apparatus of claim 5, wherein the CPE application server component provides a first one or more services to the telephony device;
wherein in response to the request from the telephony device to the CPE application server component, the CPE application server component provides a second one or more services to the telephony device.

10. The apparatus of claim 4, wherein the one or more interfaces comprise one or more eXtended Markup Language (XML) interfaces;
wherein the CPE application server component communicates with the user-related application server component to provide the one or more eXtended Markup Language interfaces.

11. The apparatus of claim 2, wherein the CPE application server component requests of the user-related application server component to establish the one or more web portals through employment of the HyperText Transport Protocol (HTTP).

12. The apparatus of claim 1, wherein the CPE application server component comprises a first application server component, further comprising:
a second application server component;
wherein the first application server component and the telephony device cooperate to establish the call;
wherein the first application server component and the second application server component provide the one or more services to the telephony device through employment of the one or more data streams.

13. The apparatus of claim 12, wherein the first application server component provides one or more interfaces associated with the one or more services that allow the telephony device to interact with the one or more services, wherein the first application server component provides the one or more interfaces to the second application server component through employment of the one or more data streams;
wherein the second application server component establishes one or more web portals with the telephony device;
wherein the first application server component and the second application server component provide the one or more interfaces through employment of the one or more web portals.

14. The apparatus of claim 13, wherein the first application server component associates the call with the one or more services, wherein the first application server component associates the one or more services with the one or more interfaces;
wherein the first application server component and the second application server component provide the one or more services that allow the telephony device to perform a request;
wherein in response to the request from the telephony device to the second application server component, the second application service component and the first application server component update the one or more services.

15. The apparatus of claim 12, wherein the first application server component comprises a voice mail system, wherein the voice mail system associates the call with a plurality of voice menus, wherein the voice mail system and the telephony device cooperate to establish a voice mail call;
wherein the voice mail system and the second application server component cooperate to provide a first voice menu of the plurality of voice menus associated with the call to the telephony device;
wherein the voice mail system and the second application server component provide one or more interfaces to allow the telephony device to perform a selection of a second voice menu of the plurality of voice menus;
wherein in response to the selection of the second voice menu from the telephony device to the voice mail system, the voice mail system updates the voice mail call to play the second voice menu to the telephony device.

16. The apparatus of claim 12, wherein the first application server component comprises a interactive voice response system, wherein the interactive voice response system associates the call with a plurality of voice menus, wherein the interactive voice response system and the telephony device cooperate to establish an interactive voice response call;
wherein the interactive voice response system and the second application server component provide a first voice menu of the plurality of voice menus associated with the interactive voice response call to the telephony device;
wherein the interactive voice response system and the second application server component provide one or more interfaces to allow the telephony device to perform a selection of a second voice menu of the plurality of voice menus;
wherein in response to the selection of the second voice menu from the telephony device to the interactive voice response system, the interactive voice response system routes the interactive voice response call.

17. A method, comprising the step of:
providing, by one or more CPEs, one or more services to a telephony device on a call through employment of one or more data streams associated with the call.

18. The method of claim 17, wherein the step of providing, by the one or more portions of Customer Premise Equipment, the one or more services to the telephony device on the call through employment of the one or more data streams associated with the call comprises the steps of:
providing one or more interfaces associated with the one or more services to the telephony device through employment of one or more web portals;
providing for a request of the one or more services through the one or more interfaces; and
updating the call based upon the request of the one or more services through the one or more interfaces.

19. The method of claim 17, wherein the step of providing, by one or more portions of Customer Premise Equipment, the one or more services to the telephony device on the call through employment of the one or more data streams associated with the call comprises the steps of:
providing for an employment of the one or more services through the one or more interfaces; and
routing the call based upon the employment of the one or more services.

20. An article, comprising:
one or more computer-readable signal-bearing media;
means in the one or more media for providing, by one or more CPEs, one or more services to a telephony device on a call through employment of one or more data streams associated with the call.
